(19) United States
(12) Patent Application Publication
(10) Pub. No.: US 2024/0375646 A1
(43) Pub. Date: Nov. 14, 2024

(54) Backup or Stopping Hazards

(71) Applicant: Nissan North America, Inc., Franklin, TN (US)

(72) Inventors: Qizhan Tam, San Jose, CA (US); Christopher Ostafew, Mountain View, CA (US)

(21) Appl. No.: 18/333,349

(22) Filed: Jun. 12, 2023

Related U.S. Application Data
(60) Provisional application No. 63/464,791, filed on May 8, 2023.

(51) Int. Cl. B60W 30/095; B60W 30/09; B60W 30/16; B60W 50/00; B60W 60/00

(52) U.S. Cl. CPC B60W 30/0956; B60W 30/09; B60W 30/16; B60W 50/0097; B60W 60/0015; B60W 2554/20; B60W 2554/4026; B60W 2554/4029; B60W 2554/4046; B60W 2554/80

(57) ABSTRACT

A system can determine, from a vehicle traversing in a vehicle transportation network, movement information associated with an object traveling in front of the vehicle and road information associated with the vehicle transportation network. The system can then determine a probability of the object representing a backup or stopping (BoS) hazard to the vehicle. The probability can be based on the movement information and the road information. The system can then assign a BoS classification to the object based on the probability exceeding a threshold. The system can then calculate, based on assigning the BoS classification, a risk zone representing a target minimum separation distance between the vehicle and the object. The system can then control the vehicle to avoid the risk zone by constraining a speed of the vehicle.

### CROSS-REFERENCE TO RELATED APPLICATION(S)

This application claims priority to and the benefit of U.S. Provisional Patent Application Ser. No. 63/464,791, filed May 8, 2023, the entire disclosure of which is hereby incorporated by reference.

### TECHNICAL FIELD

This application relates to risk mitigation for autonomous vehicles, including determining and mitigating backup or stopping hazards.

### BACKGROUND

Increasing autonomous vehicle (AV) usage creates the potential for more efficient movement of passengers and cargo through a transportation network. Moreover, the use of AVs can result in improved vehicle safety and more effective communication between vehicles. However, external objects can make traversing the transportation network difficult.

### SUMMARY

Disclosed herein are aspects, features, elements, implementations, and embodiments of determining and mitigating backup or stopping (BoS) hazards.

An aspect of the disclosed implementations is a method related to risk mitigation for an AV. The method may include determining, from a vehicle traversing in a vehicle transportation network, movement information associated with an object traveling in front of the vehicle and road information associated with the vehicle transportation network. The method can further include determining a probability of the object representing a BoS hazard to the vehicle. The probability can be based on the movement information and the road information. The method can further include assigning a BoS classification to the object based on the probability exceeding a threshold. The method can further include calculating, based on assigning the BoS classification, a risk zone representing a target minimum separation distance between the vehicle and the object. The method can further include controlling the vehicle to avoid the risk zone by constraining a speed of the vehicle.

In some implementations, the method may include removing the BoS classification based on a reduction in the probability. The reduction may be caused by a determination that the object is resuming a predicted trajectory. In some implementations, the method may include removing the BoS classification based on a reduction in the probability. The reduction may be caused by at least one of the object exceeding a range from the vehicle or the object transitioning to a stationary hazard. In some implementations, determining the movement information may include comparing an acceleration of the object to a prediction of the acceleration; and determining a deviation between the acceleration and the prediction. In some implementations, determining the movement information may include comparing an angle of the object, relative to a lane in the vehicle transportation network, to a prediction of the angle; and determining a deviation between the angle and the prediction. In some implementations, the target minimum separation distance is calculated based on a multiple of a length of the vehicle. In some implementations, the object is a lead vehicle, and the risk zone is calculated to enable the lead vehicle to at least one of parallel park or complete a three point turn. In some implementations, the object is a lead vehicle, and the risk zone is calculated to enable the lead vehicle to return to a stop line after initially passing the stop line. In some implementations, the risk zone is calculated based on an estimated future position of the object. In some implementations, the method may include detecting light indicators associated with the object, wherein the probability is further based on the light indicators.

Another aspect of the disclosed implementations is an apparatus related to risk mitigation for an AV. The apparatus may include a memory and a processor configured to execute instructions stored in the memory. The processor can execute the instructions stored in the memory to determine, from a vehicle traversing in a vehicle transportation network, movement information associated with an object traveling in front of the vehicle and road information associated with the vehicle transportation network. The processor can further execute the instructions stored in the memory to determine a probability of the object representing a BoS hazard to the vehicle. The probability can be based on the movement information and the road information. The processor can further execute the instructions stored in the memory to assign a BoS classification to the object based on the probability exceeding a threshold. The processor can further execute the instructions stored in the memory to calculate, based on assigning the BoS classification, a risk zone representing a target minimum separation distance between the vehicle and the object. The processor can further execute the instructions stored in the memory to control the vehicle to avoid the risk zone by constraining a speed of the vehicle.

In some implementations, the processor is further configured to execute instructions stored in the memory to remove the risk zone based on a reduction in the probability, the reduction caused by a determination that the object is resuming a predicted trajectory. In some implementations, the processor is further configured to execute instructions stored in the memory to compare a speed of the object to a prediction of the speed; and determine a deviation between the speed and the prediction. In some implementations, the processor is further configured to execute instructions stored in the memory to compare a position of the object, relative to a lane in the vehicle transportation network, to a prediction of the position; and determine a deviation between the position and the prediction. In some implementations, the processor is further configured to execute instructions stored in the memory to determine a magnitude of a deviation from a prediction.

Another aspect of the disclosed implementations is non-transitory computer readable medium storing instructions operable to cause one or more processors to perform operations. The operations can include determining, from a vehicle traversing in a vehicle transportation network, movement information associated with an object traveling in front of the vehicle and road information associated with the vehicle transportation network. The operations can further include determining a probability of the object representing a BoS hazard to the vehicle. The probability can be based on the movement information and the road information. The operations can further include assigning a BoS classification to the object based on the probability exceeding a threshold. The operations can further include calculating, based on assigning the BoS classification, a risk zone representing a target minimum separation distance between the vehicle and the object. The operations can further include controlling the vehicle to avoid the risk zone by constraining a speed of the vehicle.

In some implementations, the road information indicates a speed limit associated with a residential area, presence of an oncoming lane, an absence of a parallel lane in the same direction, and an absence of lane markings. In some implementations, the road information includes a detection of a gap between parked vehicles. In some implementations, the operations further comprise removing the BoS classification and the risk zone based on a reduction in the probability. In some implementations, the probability is based on a number of deviations between detected and prediction conditions.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which like reference numbers refer to like elements unless otherwise noted.

FIG. 1 is a diagram of an example of a portion of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a diagram of an example of a system for determining and mitigating BoS hazards.

FIG. 4 is a diagram of an example of a vehicle assigning a BoS classification to a lead vehicle and calculating a risk zone.

FIG. 5 is an example of a graph comparing an acceleration of an object to a prediction of the acceleration and determining a deviation between the acceleration and the prediction.

FIG. 6 is an example of a graph comparing a speed of an object to a prediction of the speed and determining a deviation between the speed and the prediction.

FIG. 7 is an example of a graph comparing an angle or position of an object to a prediction of the angle or position and determining a deviation between the angle or position and the prediction.

FIG. 8 is an example of a graph for assigning a BoS classification to an object based on a probability exceeding a threshold.

FIG. 9 is an example of a graph having varying slopes for assigning a BoS classification to an object based on a probability exceeding a threshold.

FIG. 10 is a diagram of an example of a risk zone calculated to enable a lead vehicle to parallel park.

FIG. 11 is a diagram of an example of a risk zone calculated to enable a lead vehicle to complete a three point turn.

FIG. 12 is a diagram of an example of a risk zone calculated to enable a lead vehicle to back into a driveway.

FIG. 13 is a diagram of an example of a vehicle following an object.

FIG. 14 is a diagram of an example of the vehicle of FIG. 13 assigning a BoS classification and calculating a risk zone.

FIG. 15 is a diagram of an example of the vehicle of FIG. 13 removing the BoS classification and the risk zone.

FIG. 16 is an example of a method for determining and mitigating BoS hazards.

FIG. 17 is an example of a method for removing BoS hazards.

FIG. 18 is an example of a method for determining BoS hazards from movement information.

### DETAILED DESCRIPTION

A vehicle may traverse a portion of a vehicle transportation network. The vehicle transportation network can include one or more unnavigable areas, such as a building; one or more partially navigable areas, such as a parking area (e.g., a parking lot, a parking space, etc.); one or more navigable areas, such as roads (which include lanes, medians, intersections, etc.); or a combination thereof.

The vehicle may include one or more sensors. Traversing the vehicle transportation network may include the sensors generating or capturing sensor data, such as data corresponding to an operational environment of the vehicle, or a portion thereof. For example, the sensor data may include information corresponding to one or more potential hazards that materialize into or are identified as (e.g., resolve) respective external objects. Such an object may also be referred to as a hazard object (or simply object) herein.

An object can be a static object. A static object is one that is stationary and is not expected to move in the next few seconds. Examples of static objects include a bike with no rider, a cold vehicle, an empty vehicle, a road sign, a wall, a building, a pothole, etc.

An object can be a stopped object. A stopped object is one that is stationary but might move at any time. Examples of stopped objects include a vehicle that is stopped at a traffic light and a vehicle on the side of the road with an occupant (e.g., a driver). In some implementations, a stopped object may be considered a static object.

An object can be a dynamic (i.e., moving) object, such as a pedestrian, a remote vehicle, a motorcycle, a bicycle, etc. The dynamic object can be oncoming (toward the vehicle) or can be moving in the same direction as the vehicle. The dynamic object can be moving longitudinally or laterally with respect to the vehicle. A stopped object can become a dynamic object, and vice versa.

When a first vehicle is traveling behind a second vehicle (e.g., a dynamic object), the second vehicle might perform a maneuver involving an uncommon change in direction. For example, the second vehicle might slow down and begin turning to parallel park (e.g., park the vehicle parallel to the road, in line with other parked vehicles), or perform a three point turn (e.g., turning the vehicle around to face the opposite direction by using forward and reverse gears), or back into a driveway (e.g., parking the vehicle so that it faces outward to the street), or return to a stop line after initially passing the stop line (e.g., stopping too far into an intersection or crosswalk, then backing up to get out of the intersection or crosswalk). When the first vehicle is an AV, the first vehicle may stop behind the second vehicle as though the second vehicle will continue in the same direction of travel. As a result, the AV may not leave enough space for the second vehicle to perform the maneuver. This may cause disruption to traffic flow by limiting the second vehicle's ability to perform the maneuver.

Implementations of this disclosure address problems such as these by configuring a system to evaluate the likelihood that an object (e.g., a lead vehicle, or another road user, such as a cyclist or a pedestrian) will undertake a maneuver such that additional space to enable the object to perform the maneuver should be given. In some implementations, a system can determine, from a vehicle traversing in a vehicle transportation network, movement information associated with an object traveling in front of the vehicle and road information associated with the vehicle transportation network. For example, the vehicle could be an AV traveling in a residential area. The movement information could include a speed, acceleration, position, angle, or trajectory of the object. The road information could include a speed limit associated with a residential area (e.g., a relatively lower speed limit, as compared to a speed limit associated with a highway), presence of an oncoming lane, absence of a parallel lane in the same direction, or absence of lane markings. The system may utilize one or more sensors to determine movement information and the road information, such as video cameras, laser-sensing systems, infrared-sensing systems, and acoustic-sensing system. In some implementations, the system can also detect light indicators associated with the object, such as turn signals and hazard lights.

Further, the system may determine a probability of the object representing a BoS hazard to the vehicle. The probability may be based on the movement information and the road information, and in some cases, the light indicators. The object may represent a BoS hazard when there is a likelihood that the object will perform a maneuver involving an uncommon change in direction. The system may assign a BoS classification to the object based on the probability exceeding a threshold. The system may calculate, based on assigning the BoS classification, a risk zone representing a target minimum separation distance between the vehicle and the object. The risk zone may represent an exclusion zone or area for the vehicle to avoid entering. The risk zone may be calculated to provide space to enable the object (e.g., the lead vehicle) to the perform a maneuver, such as parallel parking, a three point turn, backing into a driveway, or returning to a stop line after initially passing the stop line. The system may then control the vehicle to avoid the risk zone by constraining a speed of the vehicle. For example, the system may then control the vehicle to avoid the risk zone by stopping the vehicle behind the object, outside of the risk zone (e.g., maintaining the calculated target minimum separation distance between the vehicle and the object). As a result, the vehicle (e.g., the AV), may reduce disruption to traffic flow by enabling an object (e.g., the lead vehicle) to perform the maneuver.

In some implementations, the system may enable a computation of a probability that an object (e.g., the lead vehicle) is about to undertake a maneuver that involves a certain longitudinal gap to be executed safely or effectively. In some implementations, the system may in involve three components: (1) scene understanding, (2) evaluating the risk zone, and (3) conditions to remove the BoS classification and risk zone. Scene understanding may include classifying an object as a type of hazard (e.g., static, stopped, or dynamic) and/or a lead vehicle (e.g., when the object is a vehicle). Scene understanding may also include determining a type of scene in which the vehicle is traveling (e.g., residential, street parking). Scene understanding may be based on world model predictions and other perceived signals. Scene understanding may include evaluating the probability of an object (e.g., the tracked lead vehicle) exhibiting an unpredicted behavior (e.g., indicative of upcoming a maneuver, such as parallel parking, a three point turn, backing into a driveway, or returning to a stop line after initially passing the stop line). Evaluating the risk zone may include comparing a probability to a threshold. As the probability crosses the threshold, the object (e.g., the lead vehicle) may be classified as a BoS hazard. A safe distance between the vehicle and the BoS hazard may be referred to as the risk zone. In some implementations, the risk zone may be greater than the vehicle's length and have a width corresponding to the lane. The risk zone may be calculated based on an estimated future position and potential maneuvers of the BoS hazard. Conditions to remove the BoS classification and risk zone may include the object (e.g., the lead vehicle) resuming a normal behavior (e.g., the object resumes following a predicted trajectory, and no hazard lights are detected). Conditions to remove the BoS classification and risk zone may also include the object getting out of range of the vehicle, or the object transitioning to a different hazard type (e.g., a static object, such as a parked vehicle).

Thus, the system can ensure that the vehicle (e.g., the AV) remains at a safe distance from an object (e.g., the lead vehicle) that may intrude into the risk zone, thereby increasing safety. The system can also proactively maintain the target minimum separation distance. This may enable the vehicle to avoid backing-up or decelerating rapidly in response to the object, thereby increasing comfort. The system can also anticipate the actions of the object (e.g., the lead vehicle's driver) and enact actions that a human driver would normally do as a common courtesy, thereby increasing social awareness.

To describe some implementations in greater detail, reference is first made to examples of hardware and software structures used to implement a system for determining (BoS) hazards.

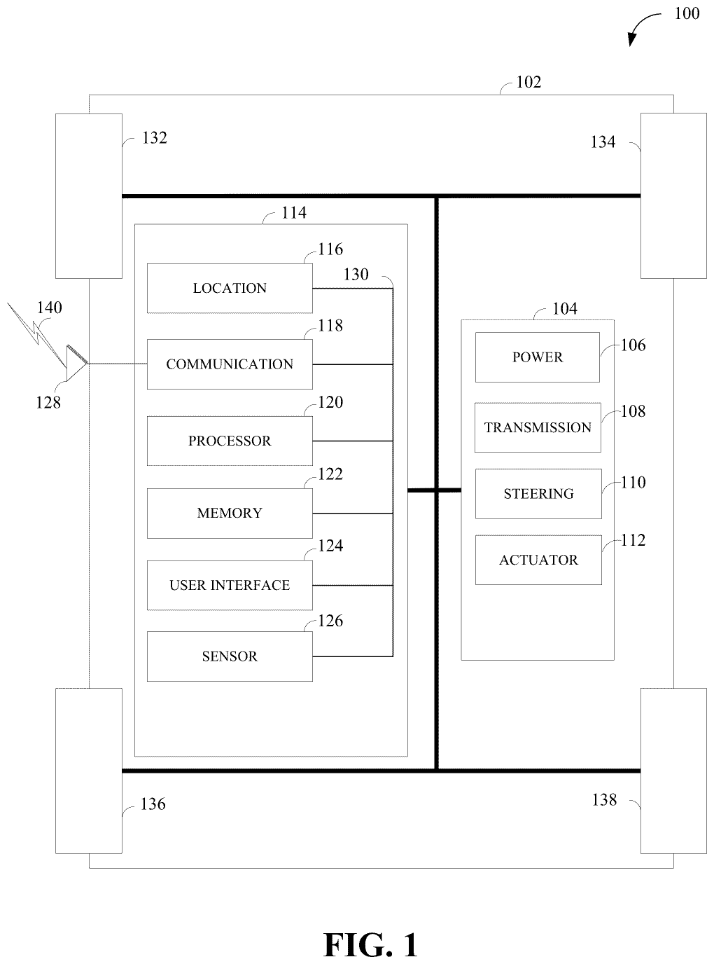

FIG. 1 is a diagram of an example of a portion of a vehicle 100 in which the aspects, features, and elements disclosed herein may be implemented. The vehicle 100 includes a chassis 102, a powertrain 104, a controller 114, wheels 132/134/136/138, and may include any other element or combination of elements of a vehicle. Although the vehicle 100 is shown as including four wheels 132/134/136/138 for simplicity, any other propulsion device or devices, such as a propeller or tread, may be used. In FIG. 1, the lines interconnecting elements, such as the powertrain 104, the controller 114, and the wheels 132/134/136/138, indicate that information, such as data or control signals; power, such as electrical power or torque; or both information and power may be communicated between the respective elements. For example, the controller 114 may receive power from the powertrain 104 and communicate with the powertrain 104, the wheels 132/134/136/138, or both, to control the vehicle 100, which can include accelerating, decelerating, steering, or otherwise controlling the vehicle 100.

The powertrain 104 includes a power source 106, a transmission 108, a steering unit 110, a vehicle actuator 112, and may include any other element or combination of elements of a powertrain, such as a suspension, a drive shaft, axles, or an exhaust system. Although shown separately, the wheels 132/134/136/138 may be included in the powertrain 104.

The power source 106 may be any device or combination of devices operative to provide energy, such as electrical energy, thermal energy, or kinetic energy. For example, the power source 106 includes an engine, such as an internal combustion engine, an electric motor, or a combination of an internal combustion engine and an electric motor, and is operative to provide kinetic energy as a motive force to one or more of the wheels 132/134/136/138. In some embodiments, the power source 106 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 108 receives energy, such as kinetic energy, from the power source 106 and transmits the energy to the wheels 132/134/136/138 to provide a motive force. The transmission 108 may be controlled by the controller 114, the vehicle actuator 112, or both. The steering unit 110 may be controlled by the controller 114, the vehicle actuator 112, or both and controls the wheels 132/134/136/138 to steer the vehicle. The vehicle actuator 112 may receive signals from the controller 114 and may actuate or control the power source 106, the transmission 108, the steering unit 110, or any combination thereof to operate the vehicle 100.

In the illustrated embodiment, the controller 114 includes a location unit 116, an electronic communication unit 118, a processor 120, a memory 122, a user interface 124, a sensor 126, and an electronic communication interface 128. Although shown as a single unit, any one or more elements of the controller 114 may be integrated into any number of separate physical units. For example, the user interface 124 and the processor 120 may be integrated in a first physical unit, and the memory 122 may be integrated in a second physical unit. Although not shown in FIG. 1, the controller 114 may include a power source, such as a battery. Although shown as separate elements, the location unit 116, the electronic communication unit 118, the processor 120, the memory 122, the user interface 124, the sensor 126, the electronic communication interface 128, or any combination thereof can be integrated in one or more electronic units, circuits, or chips.

In some embodiments, the processor 120 includes any device or combination of devices, now-existing or hereafter developed, capable of manipulating or processing a signal or other information, for example optical processors, quantum processors, molecular processors, or a combination thereof. For example, the processor 120 may include one or more special-purpose processors, one or more digital signal processors, one or more microprocessors, one or more controllers, one or more microcontrollers, one or more integrated circuits, one or more Application Specific Integrated Circuits, one or more Field Programmable Gate Arrays, one or more programmable logic arrays, one or more programmable logic controllers, one or more state machines, or any combination thereof. The processor 120 may be operatively coupled with the location unit 116, the memory 122, the electronic communication interface 128, the electronic communication unit 118, the user interface 124, the sensor 126, the powertrain 104, or any combination thereof. For example, the processor may be operatively coupled with the memory 122 via a communication bus 130.

The processor 120 may be configured to execute instructions. Such instructions may include instructions for remote operation, which may be used to operate the vehicle 100 from a remote location, including the operations center. The instructions for remote operation may be stored in the vehicle 100 or received from an external source, such as a traffic management center, or server computing devices, which may include cloud-based server computing devices. The processor 120 may also implement some or all of the risk mitigation described herein, including determining and mitigating BoS hazards.

The memory 122 may include any tangible non-transitory computer-usable or computer-readable medium capable of, for example, containing, storing, communicating, or transporting machine-readable instructions or any information associated therewith, for use by or in connection with the processor 120. The memory 122 may include, for example, one or more solid state drives, one or more memory cards, one or more removable media, one or more read-only memories (ROM), one or more random-access memories (RAM), one or more registers, one or more low power double data rate (LPDDR) memories, one or more cache memories, one or more disks (including a hard disk, a floppy disk, or an optical disk), a magnetic or optical card, or any type of non-transitory media suitable for storing electronic information, or any combination thereof.

The electronic communication interface 128 may be a wireless antenna, as shown, a wired communication port, an optical communication port, or any other wired or wireless unit capable of interfacing with a wired or wireless electronic communication medium 140.

The electronic communication unit 118 may be configured to transmit or receive signals via the wired or wireless electronic communication medium 140, such as via the electronic communication interface 128. Although not explicitly shown in FIG. 1, the electronic communication unit 118 is configured to transmit, receive, or both via any wired or wireless communication medium, such as radio frequency (RF), ultraviolet (UV), visible light, fiber optic, wire line, or a combination thereof. Although FIG. 1 shows a single one of the electronic communication unit 118 and a single one of the electronic communication interface 128, any number of communication units and any number of communication interfaces may be used. In some embodiments, the electronic communication unit 118 can include a dedicated short-range communications (DSRC) unit, a wireless safety unit (WSU), IEEE 802.11p (WiFi-P), or a combination thereof.

The location unit 116 may determine geolocation information, including but not limited to longitude, latitude, elevation, direction of travel, or speed, of the vehicle 100. For example, the location unit includes a global positioning system (GPS) unit, such as a Wide Area Augmentation System (WAAS) enabled National Marine Electronics Association (NMEA) unit, a radio triangulation unit, or a combination thereof. The location unit 116 can be used to obtain information that represents, for example, a current heading of the vehicle 100, a current position of the vehicle 100 in two or three dimensions, a current angular orientation of the vehicle 100, or a combination thereof.

The user interface 124 may include any unit capable of being used as an interface by a person, including any of a virtual keypad, a physical keypad, a touchpad, a display, a touchscreen, a speaker, a microphone, a video camera, a sensor, and a printer. The user interface 124 may be operatively coupled with the processor 120, as shown, or with any other element of the controller 114. Although shown as a single unit, the user interface 124 can include one or more physical units. For example, the user interface 124 includes an audio interface for performing audio communication with a person, and a touch display for performing visual and touch-based communication with the person.

The sensor 126 may include one or more sensors, such as an array of sensors, which may be operable to provide information that may be used to control the vehicle. The sensor 126 can provide information regarding current operating characteristics of the vehicle or its surroundings (e.g., movement information associated with an object traveling in front of the vehicle, and road information associated with a vehicle transportation network). The sensor 126 includes, for example, a speed sensor, acceleration sensors, a steering angle sensor, traction-related sensors, braking-related sensors, or any sensor, or combination of sensors, that is operable to report information regarding some aspect of the current dynamic situation of the vehicle 100.

In some embodiments, the sensor 126 includes sensors that are operable to obtain information regarding the physical environment surrounding the vehicle 100. For example, one or more sensors detect road geometry and obstacles, such as fixed obstacles, vehicles, cyclists, and pedestrians. The sensor 126 can be or include one or more video cameras, laser-sensing systems, infrared-sensing systems, acoustic-sensing systems, or any other suitable type of on-vehicle environmental sensing device, or combination of devices, now known or later developed. The sensor 126 and the location unit 116 may be combined.

Although not shown separately, the vehicle 100 may include a trajectory controller. For example, the controller 114 may include a trajectory controller. The trajectory controller may be operable to obtain information describing a current state of the vehicle 100 and a route planned for the vehicle 100, and, based on this information, to determine and optimize a trajectory for the vehicle 100. In some embodiments, the trajectory controller outputs signals operable to control the vehicle 100 such that the vehicle 100 follows the trajectory that is determined by the trajectory controller. For example, the output of the trajectory controller can be an optimized trajectory that may be supplied to the powertrain 104, the wheels 132/134/136/138, or both. The optimized trajectory can be a control input, such as a set of steering angles, with each steering angle corresponding to a point in time or a position. The optimized trajectory can be one or more paths, lines, curves, or a combination thereof.

One or more of the wheels 132/134/136/138 may be a steered wheel, which is pivoted to a steering angle under control of the steering unit 110; a propelled wheel, which is torqued to propel the vehicle 100 under control of the transmission 108; or a steered and propelled wheel that steers and propels the vehicle 100.

A vehicle may include units or elements not shown in FIG. 1, such as an enclosure, a Bluetooth® module, a frequency modulated (FM) radio unit, a Near-Field Communication (NFC) module, a liquid crystal display (LCD) display unit, an organic light-emitting diode (OLED) display unit, a speaker, or any combination thereof.

The vehicle, such as the vehicle 100, may be an autonomous vehicle or a semi-autonomous vehicle. For example, as used herein, an autonomous vehicle as used herein should be understood to encompass a vehicle that includes an advanced driver assist system (ADAS). An ADAS can automate, adapt, and/or enhance vehicle systems for safety and better driving such as by circumventing or otherwise correcting driver errors.

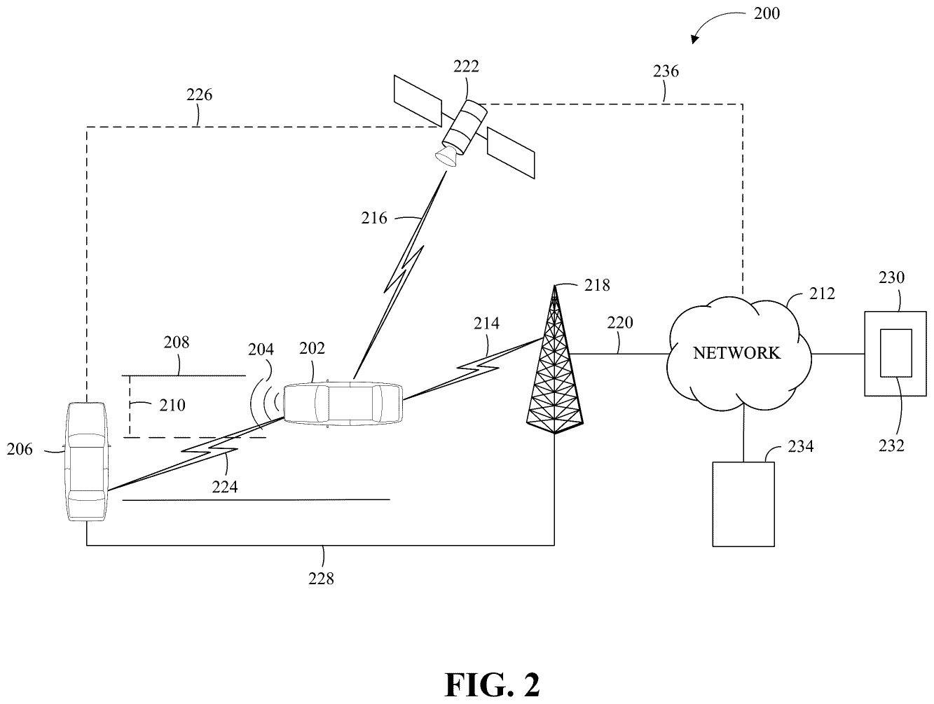

FIG. 2 is a diagram of an example of a portion of a vehicle transportation and communication system 200 in which the aspects, features, and elements disclosed herein may be implemented. The vehicle transportation and communication system 200 includes a vehicle 202, such as the vehicle 100 shown in FIG. 1, and one or more external objects, such as an external object 206, which can include any form of transportation, such as the vehicle 100 shown in FIG. 1, a pedestrian, cyclist, as well as any form of a structure, such as a building. The vehicle 202 may travel via one or more portions of a transportation network 208, and may communicate with the external object 206 via one or more of an electronic communication network 212. Although not explicitly shown in FIG. 2, a vehicle may traverse an area that is not expressly or completely included in a transportation network, such as an off-road area. In some embodiments, the transportation network 208 may include one or more of a vehicle detection sensor 210, such as an inductive loop sensor, which may be used to detect the movement of vehicles on the transportation network 208.

The electronic communication network 212 may be a multiple access system that provides for communication, such as voice communication, data communication, video communication, messaging communication, or a combination thereof, between the vehicle 202, the external object 206, and an operations center 230. For example, the vehicle 202 or the external object 206 may receive information, such as information representing the transportation network 208, from the operations center 230 via the electronic communication network 212.

The operations center 230 includes a controller apparatus 232, which includes some or all of the features of the controller 114 shown in FIG. 1. The controller apparatus 232 can monitor and coordinate the movement of vehicles, including autonomous vehicles. The controller apparatus 232 may monitor the state or condition of vehicles, such as the vehicle 202, and external objects, such as the external object 206. The controller apparatus 232 can receive vehicle data and infrastructure data including any of: vehicle velocity; vehicle location; vehicle operational state; vehicle destination; vehicle route; vehicle sensor data; external object velocity; external object location; external object operational state; external object destination; external object route; and external object sensor data.

Further, the controller apparatus 232 can establish remote control over one or more vehicles, such as the vehicle 202, or external objects, such as the external object 206. In this way, the controller apparatus 232 may teleoperate the vehicles or external objects from a remote location. The controller apparatus 232 may exchange (send or receive) state data with vehicles, external objects, or a computing device, such as the vehicle 202, the external object 206, or a server computing device 234, via a wireless communication link, such as the wireless communication link 226, or a wired communication link, such as the wired communication link 228.

The server computing device 234 may include one or more server computing devices, which may exchange (send or receive) state signal data with one or more vehicles or computing devices, including the vehicle 202, the external object 206, or the operations center 230, via the electronic communication network 212.

In some embodiments, the vehicle 202 or the external object 206 communicates via the wired communication link 228, a wireless communication link 214/216/224, or a combination of any number or types of wired or wireless communication links. For example, as shown, the vehicle 202 or the external object 206 communicates via a terrestrial wireless communication link 214, via a non-terrestrial wireless communication link 216, or via a combination thereof. In some implementations, a terrestrial wireless communication link 214 includes an Ethernet link, a serial link, a Bluetooth link, an infrared (IR) link, an ultraviolet (UV) link, or any link capable of electronic communication.

A vehicle, such as the vehicle 202, or an external object, such as the external object 206, may communicate with another vehicle, external object, or the operations center 230. For example, a host, or subject, vehicle 202 may receive one or more automated inter-vehicle messages, such as a basic safety message (BSM), from the operations center 230 via a direct communication link 224 or via an electronic communication network 212. For example, the operations center 230 may broadcast the message to host vehicles within a defined broadcast range, such as three hundred meters, or to a defined geographical area. In some embodiments, the vehicle 202 receives a message via a third party, such as a signal repeater (not shown) or another remote vehicle (not shown). In some embodiments, the vehicle 202 or the external object 206 transmits one or more automated inter-vehicle messages periodically based on a defined interval, such as one hundred milliseconds.

The vehicle 202 may communicate with the electronic communication network 212 via an access point 218. The access point 218, which may include a computing device, is configured to communicate with the vehicle 202, with the electronic communication network 212, with the operations center 230, or with a combination thereof via wired or wireless communication links 214/220. For example, an access point 218 is a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit, an access point can include any number of interconnected elements.

The vehicle 202 may communicate with the electronic communication network 212 via a satellite 222 or other non-terrestrial communication device. The satellite 222, which may include a computing device, may be configured to communicate with the vehicle 202, with the electronic communication network 212, with the operations center 230, or with a combination thereof via one or more communication links 216/236. Although shown as a single unit, a satellite can include any number of interconnected elements.

The electronic communication network 212 may be any type of network configured to provide for voice, data, or any other type of electronic communication. For example, the electronic communication network 212 includes a local area network (LAN), a wide area network (WAN), a virtual private network (VPN), a mobile or cellular telephone network, the Internet, or any other electronic communication system. The electronic communication network 212 may use a communication protocol, such as the Transmission Control Protocol (TCP), the User Datagram Protocol (UDP), the Internet Protocol (IP), the Real-time Transport Protocol (RTP), the Hyper Text Transport Protocol (HTTP), or a combination thereof. Although shown as a single unit, an electronic communication network can include any number of interconnected elements.

In some embodiments, the vehicle 202 communicates with the operations center 230 via the electronic communication network 212, access point 218, or satellite 222. The operations center 230 may include one or more computing devices, which are able to exchange (send or receive) data from a vehicle, such as the vehicle 202; data from external objects, including the external object 206; or data from a computing device, such as the server computing device 234.

In some embodiments, the vehicle 202 identifies a portion or condition of the transportation network 208. For example, the vehicle 202 may include one or more on-vehicle sensors 204, such as the sensor 126 shown in FIG. 1, which includes a speed sensor, a wheel speed sensor, a camera, a gyroscope, an optical sensor, a laser sensor, a radar sensor, a sonic sensor, or any other sensor or device or combination thereof capable of determining or identifying a portion or condition of the transportation network 208.

The vehicle 202 may traverse one or more portions of the transportation network 208 using information communicated via the electronic communication network 212, such as information representing the transportation network 208, information identified by one or more on-vehicle sensors 204, or a combination thereof. The external object 206 may be capable of all or some of the communications and actions described above with respect to the vehicle 202.

For simplicity, FIG. 2 shows the vehicle 202 as the host vehicle, the external object 206, the transportation network 208, the electronic communication network 212, and the operations center 230. However, any number of vehicles, networks, or computing devices may be used. In some embodiments, the vehicle transportation and communication system 200 includes devices, units, or elements not shown in FIG. 2.

Although the vehicle 202 is shown communicating with the operations center 230 via the electronic communication network 212, the vehicle 202 (and the external object 206) may communicate with the operations center 230 via any number of direct or indirect communication links. For example, the vehicle 202 or the external object 206 may communicate with the operations center 230 via a direct communication link, such as a Bluetooth communication link. Although, for simplicity, FIG. 2 shows one of the transportation network 208 and one of the electronic communication network 212, any number of networks or communication devices may be used.

The external object 206 is illustrated as a second, remote vehicle in FIG. 2. An external object is not limited to another vehicle. An external object may be any infrastructure element, for example, a fence, a sign, a building, etc., that has the ability transmit data to the operations center 230. The data may be, for example, sensor data from the infrastructure element.

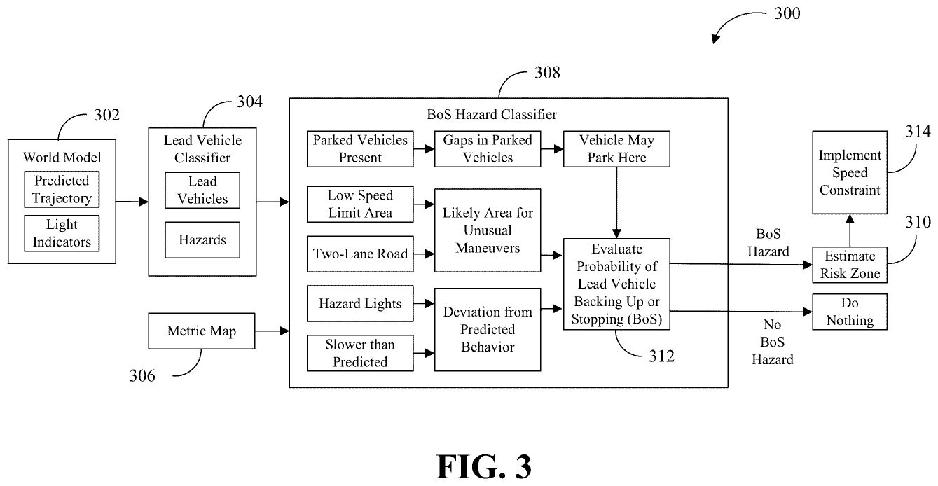

FIG. 3 is a diagram of an example of a system 300 for determining and mitigating BoS hazards. Although described in connection with a vehicle traveling through a vehicle transportation network, such as the transportation network 208, the teachings herein may be used in any area navigable by a vehicle. The system 300 may represent a software pipeline of a vehicle, such as the vehicle 100 of FIG. 1 or the vehicle 202 of FIG. 2. The system 300 includes a world model 302 (including world model objects), a lead object classifier 304, a metric map 306, a BoS hazard classifier 308, and a risk zone calculator 310. Other examples of the system 300 can include more, fewer, or other components. In some examples, the components can be combined; in other examples, a component can be divided into more than one component.

The world model 302 receives sensor data, such as from the sensor 126 of FIG. 1, and determines (e.g., converts to, or detects) objects from the sensor data. That is, the world model 302 determines hazard objects (e.g., road users) from the received sensor data. For example, the world model 302 can convert a point cloud received from a light detection and ranging (LiDAR) sensor (i.e., a sensor of the sensor 126) into an object, such as a hazard object. Sensor data from several sensors can be fused together to identify the objects. Examples of objects include a non-motorized vehicle (e.g., a bicycle), a pedestrian or animal, and a motorized vehicle (e.g., a lead vehicle). In some implementations, the world model 302 can also detect light indicators associated with objects, such as turn signals and hazard lights activated on vehicles.

The world model 302 can receive sensor information that allows the world model 302 to calculate and maintain additional information for at least some of the detected objects. For example, the world model 302 can maintain a state for at least some of the determined objects. The state for an object can include movement information associated with an object, such as zero or more of a velocity, an acceleration, a position, an angle, a trajectory, a pose, a geometry (such as width, height, and depth), a classification (e.g., bicycle, large truck, pedestrian, road sign, etc.), and a location. As such, the state of an object includes discrete state information (e.g., classification) and continuous state information (e.g., velocity, acceleration, position, angle, trajectory, and pose).

The world model 302 fuses sensor information, tracks objects, maintains lists of hypotheses for at least some of the dynamic objects (e.g., an object A might be going straight, turning right, or turning left), creates and maintains predicted trajectories for each hypothesis, and maintains likelihood estimates of each hypothesis (e.g., object A is going straight with probability 90% considering the object pose/velocity and the trajectory poses/velocities). In an example, the world model 302 uses an instance of a trajectory planner to generate the predicted trajectories for each object hypothesis for at least some of the dynamic objects. For example, an instance of the trajectory planner can be used to generate predicted trajectories for vehicles, bicycles, and pedestrians. In another example, an instance of a trajectory planner can be used to generate predicted trajectories for vehicles and bicycles, and a different method can be used to generate predicted trajectories for pedestrians.

The objects maintained by the world model 302 can include hazard objects, which can include static objects, dynamic objects, or both. The lead object classifier 304 receives objects from the world model 302 and further classifies the objects as lead objects (e.g., lead vehicles) or other hazards (e.g., hazards that are not a lead object, such as a lead vehicle). A lead object is an object that is in front of the vehicle implementing the system 300. As discussed herein by way of example, a lead object may be a lead vehicle. However, in some cases, the lead object could be a non-vehicle, such as a bicycle or a pedestrian.

The BoS hazard classifier 308 receives objects identified as lead objects from the lead object classifier 304. The BoS hazard classifier 308 also receives the metric map 306, which may include road information associated with the transportation network in which a lead object is encountered. For example, the road information may include maps, speed limits, indications of oncoming lanes, indications of parallel lanes, and indications of lane markings. The BoS hazard classifier 308 may determine a probability of the object (e.g., the lead object, such as a lead vehicle) representing a BoS hazard (e.g., to the vehicle implementing the system 300). The probability may be based on the movement information and the road information, and in some cases, the light indicators. The object may represent a BoS hazard when there is a likelihood that the object will perform a maneuver involving an uncommon change in direction. The BoS hazard classifier 308 may implement an evaluator 312 to evaluate a probability of the object backing up or stopping.

In one example, the evaluator 312 may receive input indicating a presence of parked vehicles in a line and gaps between the parked vehicles (e.g., road information). This may indicate to the evaluator 312 that the object (e.g., the lead vehicle) may parallel park in a gap between parked vehicles. In another example, the evaluator 312 may receive input indicating a relatively lower speed limit area, such as a speed limit associated with a residential area, and presence of a two-lane road, such as presence of an oncoming lane, absence of a parallel lane in the same direction, and an absence of lane markings (e.g., road information). This may indicate to the evaluator 312 that the object is in area where the object may perform an unusual maneuver (e.g., parallel parking, a three point turn, or backing into a driveway). In another example, the evaluator 312 may receive input indicating the object has activated hazard lights, or a turn signal, and that a speed of the object is slower than predicted (e.g., movement information). This may indicate to the evaluator 312 that the object is deviating from a predicted behavior for the object (e.g., predicted by the system 300). Based on the various input (e.g., the road information and the movement information), the evaluator 312 may assign a BoS classification to the object (e.g., “BoS Hazard”) or not assign a BoS classification to the object (e.g., “Not BoS Hazard”). The evaluator 312 may assign the BoS classification based on the probability exceeding a threshold.

The BoS hazard classifier 308, via the evaluator 312, may generate the BoS classification. The risk zone calculator 310 may calculate, based on assigning the BoS classification to the object (e.g., the lead vehicle), a risk zone representing a target minimum separation distance between the vehicle and the object. The risk zone may be calculated based on an estimated future position of the object. The risk zone may be calculated to enable the object to the perform a maneuver, such as parallel parking, a three point turn, backing into a driveway, or returning to a stop line after initially passing the stop line. The risk zone calculator 310 may output the risk zone to a motion controller 314 to implement. The motion controller 314 may then control the vehicle to avoid the risk zone by constraining a speed of the vehicle. For example, the motion controller 314 may control the vehicle to avoid the risk zone by stopping the vehicle behind the object, outside of the risk zone (e.g., maintaining the calculated target minimum separation distance between the vehicle and the object). In some implementations, the target minimum separation distance may be calculated based on a multiple of a length of the vehicle. For example, the distance could be one length of the vehicle, two lengths of the vehicle, and so forth. In some implementations, the risk zone may have a width corresponding to the lane in which the vehicle is traveling in the transportation network. The distance may depend on the movement information (e.g., the speed of the object) and/or the road information (e.g., the speed limit, presence of a two-lane road, an oncoming lane, a parallel lane in the same direction, and lane markings).

The system 300 may continuously update when the vehicle is traveling. For example, at a first time step, an object (e.g., a lead vehicle) may appear as a hazard, but may not be classified a BoS hazard (e.g., not assigned the BoS classification). At a second time step, the object may become a BoS hazard (e.g., assigned the BoS classification), such as when the object slows down when the object should be going faster (e.g., a driver of the lead vehicle is looking for a parking space). The vehicle can then calculate the risk zone and control the vehicle to avoid the risk zone by constraining the speed (e.g., while the driver of the lead vehicle is looking for the parking space, and/or beings to parallel park). At a third time step, the object may no longer be a BoS hazard (e.g., after the lead vehicle has parked), and the BoS classification and the risk zone may be removed.

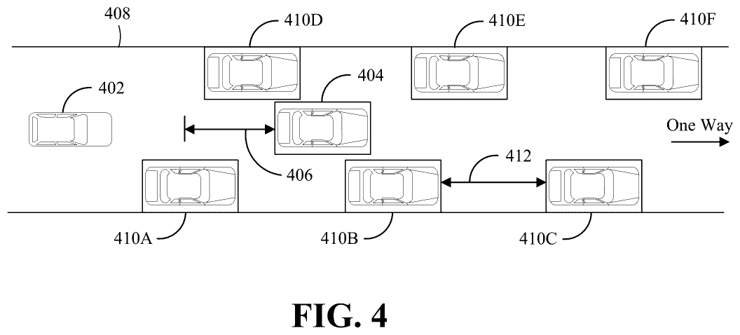

FIG. 4 is a diagram of an example of a vehicle 402 assigning a BoS classification to a lead vehicle 404 and calculating a risk zone 406. For example, the vehicle 402 may be the vehicle 100 of FIG. 1 or the vehicle 202 of FIG. 2. The vehicle 402 may the system 300 of FIG. 3. The vehicle 402 may be traversing in a vehicle transportation network 408, such as the transportation network 208 of FIG. 2. The vehicle 402 may encounter the lead vehicle 404 as an object traveling in front of the vehicle 402. The vehicle 402 (e.g., via the system 300) may obtain movement information associated with the lead vehicle 404 and road information associated with the vehicle transportation network 408 (e.g., scene understanding). In this example, the movement information may indicate that the lead vehicle 404 is deviating from a predicted behavior for the lead vehicle 404, such as a speed of the lead vehicle 404 being slower than predicted. The road information may indicate a presence of parked vehicles in a line, such as parked vehicles 410A to 410F, and gaps between the parked vehicles, such as a gap 412 between parked vehicles 410B and 410C. The road information may also indicate that the lead vehicle 404 is in an area of the vehicle transportation network 408 having a relatively lower speed limit area, such as a speed limit associated with a residential area, that there is a presence of an oncoming lane, an absence of a parallel lane in the same direction, and an absence of lane markings.

The vehicle 402 (e.g., via the system 300) may then determine, based on the movement information and the road information, a probability of the lead vehicle 404 representing a BoS hazard to the vehicle 402 (e.g., evaluating the risk zone). In this case, the vehicle 402 may determine the lead vehicle 404 does represent a BoS hazard (e.g., the probability exceeding a threshold). This may result from the lead vehicle 404 exhibiting a maneuver to parallel park in the gap 412. The vehicle 402 may then assign a BoS classification to the lead vehicle 404 based on the probability exceeding the threshold, and proceed to calculate the risk zone 406 representing a target minimum separation distance between the vehicle 402 and the lead vehicle 404. The risk zone 406 may provide sufficient space for the lead vehicle 404 to perform the maneuver (e.g., parallel park in the gap 412). After the lead vehicle 404 has performed the maneuver (e.g., parked in the gap 412), the vehicle 402 may remove the BoS classification, and the risk zone 406, and proceed normally in the vehicle transportation network 408 (e.g., conditions removed).

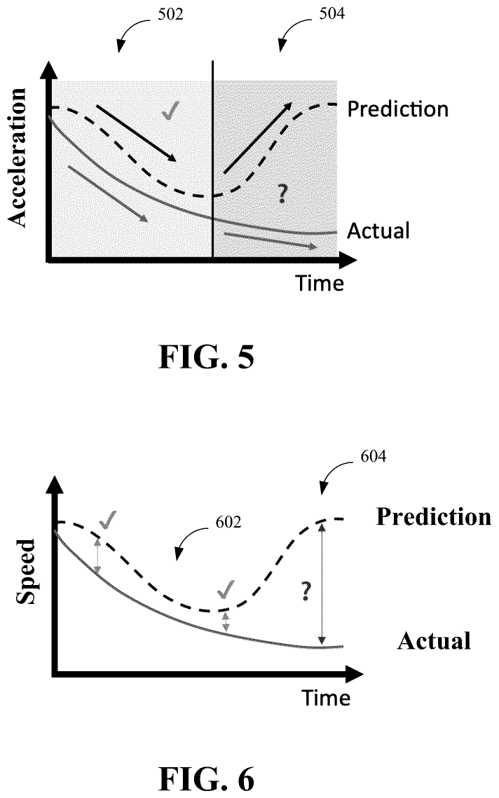

FIG. 5 is an example of a graph comparing an acceleration of an object to a prediction of the acceleration and determining a deviation between the acceleration and the prediction. For example, a system implemented by a vehicle, such as the system 300 of FIG. 3 implemented by the vehicle 100 of FIG. 1, the vehicle 202 of FIG. 2, or the vehicle 402 of FIG. 4, may predict an acceleration of an object (e.g., prediction). The object may be a lead object, such as the lead vehicle 404. The system may also determine an actual acceleration of the object (e.g., actual). The system may then compare the actual acceleration to the prediction to determine a deviation between the actual acceleration and the prediction. This may be used an indicator used by the system to predict an upcoming maneuver, such as parallel parking. For example, a first time 502 may result in a deviation within an acceleration threshold (e.g., indicating the object is operating normally, following a predicted trend). This may correspond to a lower probability of the object representing a BoS hazard. A second time 504 may result in a deviation that exceeds the acceleration threshold (e.g., indicating the object is operating abnormally based on decelerating when a deceleration has not been predicted). This may correspond to a higher probability of the object representing a BoS hazard.

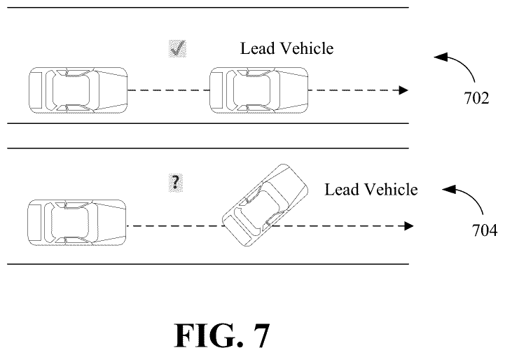

The system may similarly determine deviations with respect to other values. For example, FIG. 6 illustrates a graph comparing a speed of an object to a prediction of the speed and determining a deviation between the speed and the prediction. A first time 602 may result in a deviation within a speed threshold (e.g., indicating the object is operating normally, within error margins, and therefore a lower probability of a BoS hazard). A second time 604 may result in a deviation that exceeds the speed threshold (e.g., indicating the object is operating abnormally, slower than predicted, and therefore a higher probability of a BoS hazard). In another example, FIG. 7 illustrates a graph comparing an angle or position of an object to a prediction of the angle or position and determining a deviation between the angle or position and the prediction. A first time 702 may result in a deviation within an angle or position threshold (e.g., indicating the object is operating normally, within a range of predicted angle and lane pose, and therefore a lower probability of a BoS hazard). A second time 604 may result in a deviation that exceeds the angle or position threshold (e.g., indicating the object is operating abnormally, exceeding error thresholds, and therefore a higher probability of a BoS hazard).

Based on the deviations (e.g., acceleration, speed, position, and angle), at various times the system may assign the BoS classification to the object (e.g., the second times 504, 604, and 704), or not assign the BoS classification to the object (e.g., the first times 502, 602, and 702). In some implementations, the system may also determine a magnitude of a deviation from a prediction and utilize the magnitude when determining whether to assign the BoS classification or not assign the BoS classification to the object.

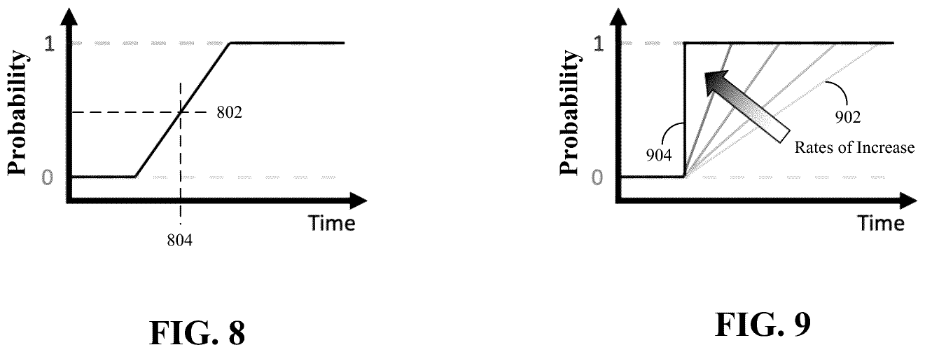

FIG. 8 is an example of a graph for assigning a BoS classification to an object based on a probability exceeding a threshold. The probability may represent a confidence of a BoS hazard that may increase over time. For example, the probability may initially be below a threshold 802, and the system (e.g., the system 300 of FIG. 3) correspondingly may not assigning the BoS classification to the object. However, the probability may increase in time. For example, an increasing number of deviation from normal operation may occur in time, such as the deviations with respect to acceleration, speed, position, and angle, shown in the second times of FIGS. 5-7). Further, the magnitudes of such deviations may also increase in time. As a result, at a time 804, the probability may exceed the threshold 802. When the probability exceeds the threshold 802, the system may then assign the BoS classification to the object.

In some cases, the rate of increase in the probability may also increase. For example, FIG. 9 is a graph having varying slopes for assigning a BoS classification to an object based on a probability exceeding a threshold. The varying slopes represent various possibilities for rates of increase in the probability due to the number of deviations, the magnitudes of the deviations, and/or the types of deviations. For example, a gradual slope 902 could correspond to a lower number of deviations, lower magnitudes of deviations, and/or lower priority types of deviations. A steeper slope 904 could correspond to a greater number of deviations, greater magnitudes of deviations, and/or higher priority types of deviations.

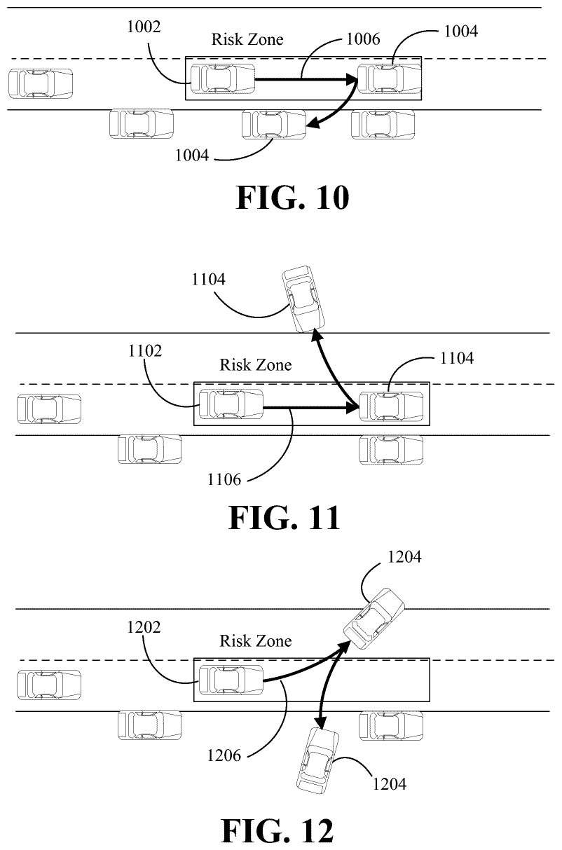

FIGS. 10-12 are examples of assigning BoS classifications to an object (e.g., a lead vehicle) and calculating risk zones to leave enough space for the object to perform a maneuver. For example, in FIG. 10, a vehicle 1002 (e.g., an AV, implementing the system 300 of FIG. 3) assigns the BoS classifications to a lead vehicle 1004, and calculates a risk zone 1006 to enable the lead vehicle 1004 to parallel park in a gap between parked vehicles (e.g., vehicle 1002 leaves enough space for the lead vehicle 1004 to perform the parking maneuver). In another example, in FIG. 11, a vehicle 1102 (e.g., an AV, implementing the system 300) assigns the BoS classifications to a lead vehicle 1104, and calculates a risk zone 1106 to enable the lead vehicle 1104 to complete a three point turn (e.g., vehicle 1102 leaves enough space for the lead vehicle 1104 to perform the turning maneuver). In another example, in FIG. 12, a vehicle 1202 (e.g., an AV, implementing the system 300) assigns the BoS classifications to a lead vehicle 1204, and calculates a risk zone 1206 to enable the lead vehicle 1204 to back into a driveway (e.g., vehicle 1202 leaves enough space for the lead vehicle 1104 to perform the backup maneuver). In another example, a vehicle (e.g., an AV, implementing the system 300) may assign the BoS classification to a lead vehicle, and calculates a risk zone to enable the lead vehicle to return to a stop line after initially passing the stop line (e.g., the vehicle leaves enough space for the lead vehicle to perform the backup maneuver).

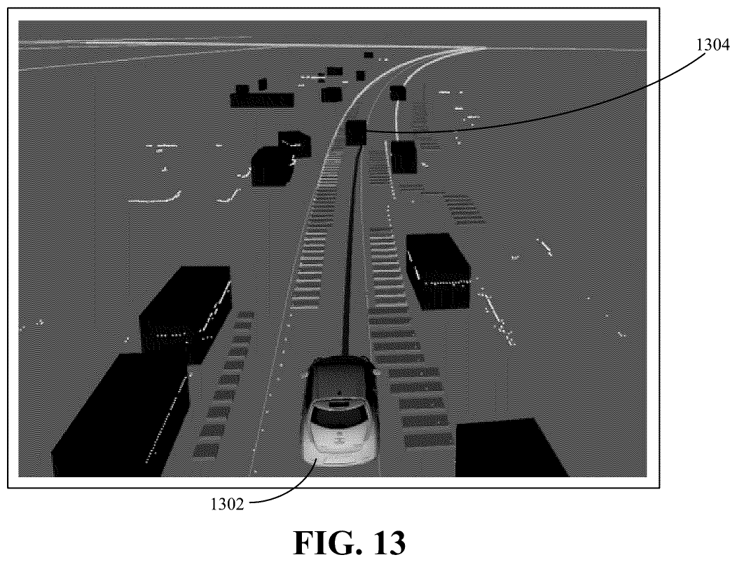

FIGS. 13-15 is an example of a system determining that an object 1304 (e.g., a lead vehicle), represents a BoS hazard, assigning a BoS classification to the object 1304, calculating a risk zone 1308 to leave enough space for the object 1304 to perform a maneuver, then removing the BoS classification and the risk zone 1308 when the object 1304 no longer represents a BoS hazard. Referring to FIG. 13, at a first time, a vehicle 1302 may be following the object 1304 in a vehicle transportation network (e.g., the object 1304 may be traveling in front of the vehicle 1302). The vehicle 1302 could be the vehicle 100 of FIG. 1, the vehicle 202 of FIG. 2, or the vehicle 402 of FIG. 4. The vehicle 1302 may implement a system like the system 300 of FIG. 3. The system may collect movement information associated with the object 1304 and road information associated with the vehicle transportation network. The system may determine a probability of the object 1304 representing a BoS hazard to the vehicle 1302. The probability may be based on the movement information and the road information. At the first time, the system may determine that the object 1304 does not represent a BoS hazard based on the probability being below a threshold. The system may therefore not assign the BoS classification to the object 1304.

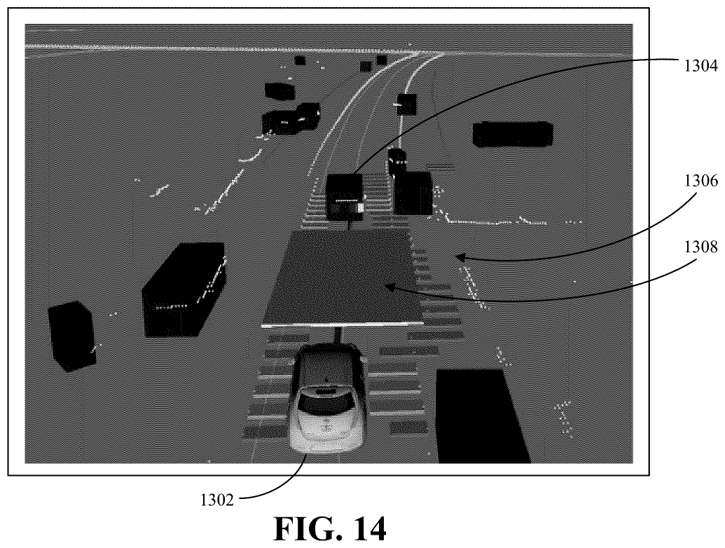

With reference to FIG. 14, at a second time, the system may collect updated movement information associated with the object 1304, and updated road information associated with the vehicle transportation network. The system may again determine a probability of the object 1304 representing a BoS hazard to the vehicle 1302. The probability may be based on the updated movement information and the updated road information. At the second time, the system may determine that the object 1304 does represent a BoS hazard based on the probability exceeding a threshold. For example, the object 1304 may be slowing down, turning on hazard lights, and attempting to parallel park in a gap 1306 between the parked vehicles, as determined from the updated movement information and the updated road information. The system may then calculate, based on assigning the BoS classification, the risk zone 1308 representing a target minimum separation distance between the vehicle 1302 and the object 1304. The system may then control the vehicle 1302 to avoid the risk zone by constraining a speed of the vehicle 1302.

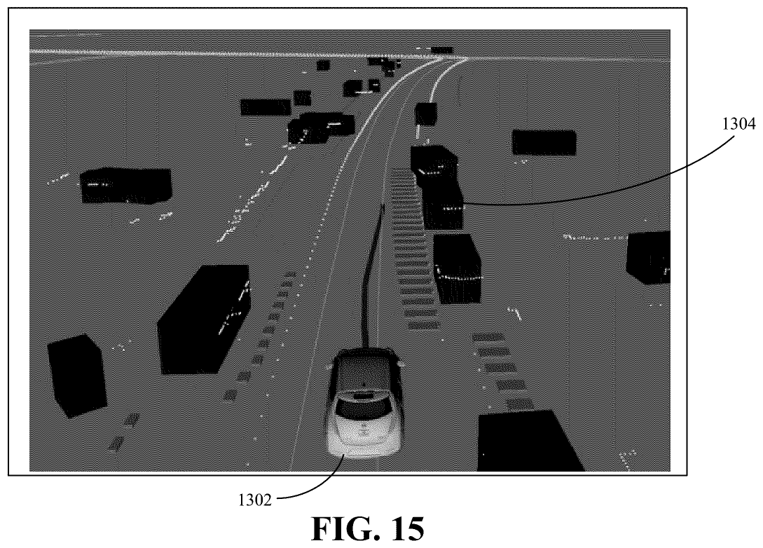

With reference to FIG. 15, at a third time, the system is may again collect updated movement information associated with the object 1304, and updated road information associated with the vehicle transportation network. The system may again determine a probability of the object 1304 representing a BoS hazard to the vehicle 1302. The probability may be based on the updated movement information and the updated road information. At the third time, the system may determine that the object 1304 does not represent a BoS hazard based on the probability falling below the threshold. For example, the object 1304 may have completed parallel parking in the gap 1306 between the parked vehicles, as determined from the updated movement information and the updated road information. The system may therefore remove the BoS classification assigned to the object 1304, and remove the risk zone 1308.

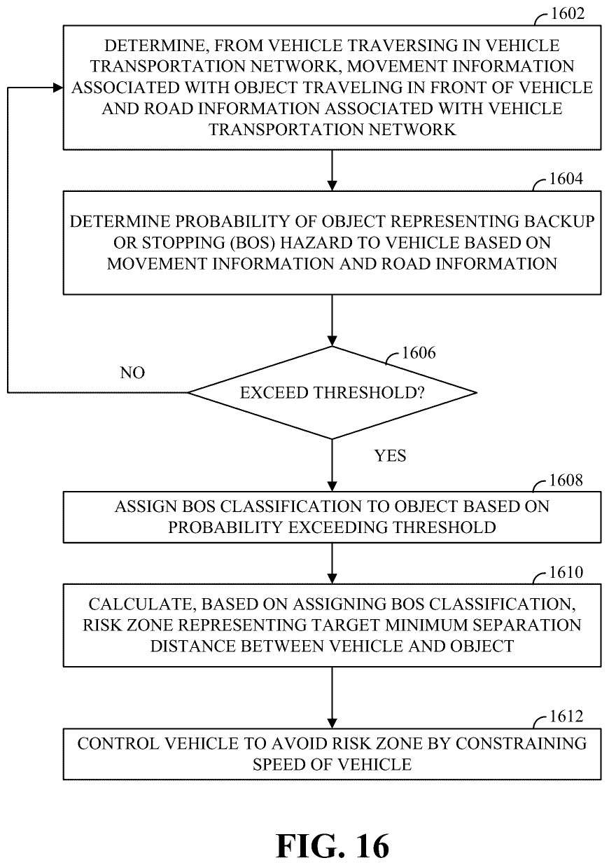

To further describe some implementations in greater detail, reference is next made to examples of techniques which may be performed based on a BoS hazard. FIG. 16 is an example of a method 1600 for determining and mitigating BoS hazards. The method 1600 can be executed using computing devices, such as the systems, hardware, and software described with respect to FIGS. 1-15. The method 1600 can be performed, for example, by executing a machine-readable program or other computer-executable instructions, such as routines, instructions, programs, or other code. The steps, or operations, of the method 1600 or another technique, method, process, or algorithm described in connection with the implementations disclosed herein can be implemented directly in hardware, firmware, software executed by hardware, circuitry, or a combination thereof.

For simplicity of explanation, the method 1600 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1602, a system can determine, from a vehicle traversing in a vehicle transportation network, movement information associated with an object traveling in front of the vehicle and road information associated with the vehicle transportation network. For example, the system could be the system 300 of FIG. 3. The system could be implemented by the controller 114 of FIG. 1. The system could be implemented by the vehicle 100 of FIG. 1, the vehicle 202 of FIG. 2, or the vehicle 402 of FIG. 4. The vehicle could be an AV. The vehicle could be traversing in the transportation network 208 of FIG. 2 or the vehicle transportation network 408 of FIG. 4. For example, the vehicle could be traveling in a residential area. The movement information could include a speed, acceleration, position, angle, or trajectory of the object. The road information could include a speed limit associated with a residential area (e.g., a relatively lower speed limit, as compared to a speed limit associated with a highway), presence of an oncoming lane, absence of a parallel lane in the same direction, or absence of lane markings. The system may utilize one or more sensors to determine movement information and the road information, such as video cameras, laser-sensing systems, infrared-sensing systems, and acoustic-sensing system. In some implementations, the system can also detect light indicators associated with the object, such as turn signals and hazard lights.

At 1604, the system can determine a probability of the object representing a BoS hazard to the vehicle. The probability may be based on the movement information and the road information, and in some cases, the light indicators. For example, the probability may indicate a likelihood that the object will perform a maneuver involving an uncommon change in direction, such as such as parallel parking, a three point turn, backing into a driveway, or returning to a stop line after initially passing the stop line. At 1606, the system can determine if the probability exceeds a threshold. If the probability does not exceed a threshold (“No”), the system can determine that the object is not a BoS hazard, and can return to step 1602. However, if the probability does exceed the threshold (“Yes”), at 1608, the system can assign a BoS classification to the object. Assigning the BoS classification to the object indicates the object represents a BoS hazard.

At 1610, the system can calculate, based on assigning the BoS classification, a risk zone representing a target minimum separation distance between the vehicle and the object. For example, the risk zone may be calculated to enable the object (e.g., the lead vehicle) to the perform a maneuver, such as parallel parking, a three point turn, backing into a driveway, or returning to a stop line after initially passing the stop line.

At 1612, the system can control the vehicle to avoid the risk zone by constraining a speed of the vehicle. For example, the system may control the vehicle to avoid the risk zone by stopping the vehicle behind the object, outside of the risk zone (e.g., maintaining the calculated target minimum separation distance between the vehicle and the object). As a result, the vehicle (e.g., the AV), may reduce disruption to traffic flow by enabling an object (e.g., the lead vehicle) to perform the maneuver.

In a further step, the system can determine if the BoS classification and/or the risk zone should be removed. For example, the system may remove the BoS classification and/or the risk zone based on a reduction in the probability. The reduction could be caused by a determination that the object is resuming a predicted trajectory, or a distance to the object exceed a range from the vehicle, or the object transitions to a stationary hazard (e.g., a parked vehicle).

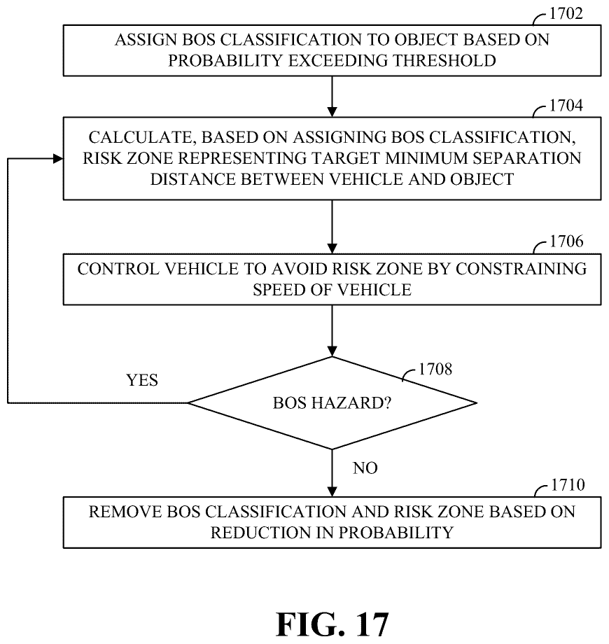

FIG. 17 is an example of a method 1700 for removing BoS hazards. The method 1700 can be executed using computing devices, such as the systems, hardware, and software described with respect to FIGS. 1-16. The method 1700 can be performed, for example, by executing a machine-readable program or other computer-executable instructions, such as routines, instructions, programs, or other code. The steps, or operations, of the method 1700 or another technique, method, process, or algorithm described in connection with the implementations disclosed herein can be implemented directly in hardware, firmware, software executed by hardware, circuitry, or a combination thereof.

For simplicity of explanation, the method 1700 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1702, a system can assign a BoS classification to an object. Assigning the BoS classification to the object indicates the object represents a BoS hazard. For example, the system could be the system 300 of FIG. 3. The system could be implemented by the controller 114 of FIG. 1. The system could be implemented by the vehicle 100 of FIG. 1, the vehicle 202 of FIG. 2, or the vehicle 402 of FIG. 4. The vehicle could be an AV. The vehicle could be traversing in the transportation network 208 of FIG. 2 or the vehicle transportation network 408 of FIG. 4. For example, the vehicle could be traveling in a residential area. For example, the system can assign the BoS classification according to the method 1600, including step 1608.

At 1704, the system can calculate, based on assigning the BoS classification, a risk zone representing a target minimum separation distance between the vehicle and the object. For example, the risk zone may be calculated to enable the object (e.g., the lead vehicle) to the perform a maneuver, such as parallel parking, a three point turn, backing into a driveway, or returning to a stop line after initially passing the stop line.

At 1706, the system can control the vehicle to avoid the risk zone by constraining a speed of the vehicle. For example, the system may control the vehicle to avoid the risk zone by stopping the vehicle behind the object, outside of the risk zone (e.g., maintaining the calculated target minimum separation distance between the vehicle and the object). The vehicle (e.g., the AV), may reduce disruption to traffic flow by enabling an object (e.g., the lead vehicle) to perform the maneuver.

At 1708, the system can determine if the object is still a BoS hazard. For example, the system can determine if the object is still a BoS hazard according to the method 1600, including steps 1602 through 1608. If the object is still a BoS hazard (“Yes”), the system can return to step 1704 to update the calculation of the risk zone, and to step 1706 to update control of the vehicle. However, if the object is no longer a BoS hazard (“No”), at 1710, the system can remove the BoS classification and the risk zone and resume normal operation. For example, the system can remove the BoS classification, and the risk zone, based on a reduction in the probability of the object representing a BoS hazard to the vehicle. In some implementations, the reduction maybe caused by a determination that the object is resuming a predicted trajectory (e.g., the vehicle operating like other vehicles, in a manner that is predictable for the area). In some implementations, the reduction may be caused by the object exceeding a range from the vehicle (e.g., the vehicle driving away, or turning onto another road). In some implementations, the reduction may be caused by the object transitioning to a stationary hazard (e.g., the vehicle parking).

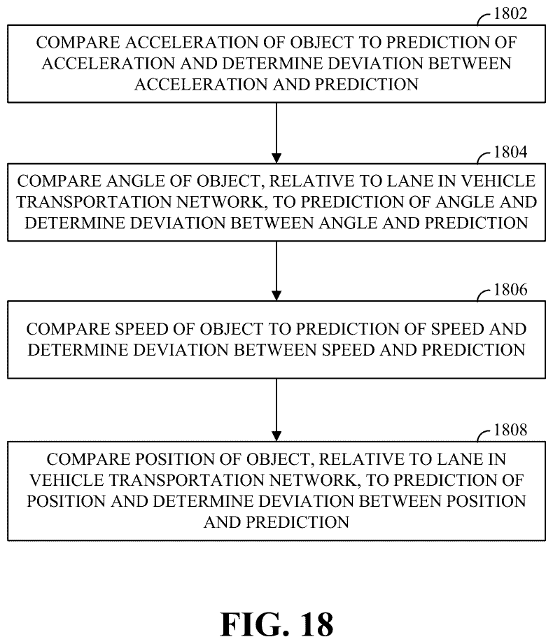

FIG. 18 is an example of a method 1800 for determining BoS hazards from movement information. The method 1800 can be executed using computing devices, such as the systems, hardware, and software described with respect to FIGS. 1-17. The method 1800 can be performed, for example, by executing a machine-readable program or other computer-executable instructions, such as routines, instructions, programs, or other code. The steps, or operations, of the method 1800 or another technique, method, process, or algorithm described in connection with the implementations disclosed herein can be implemented directly in hardware, firmware, software executed by hardware, circuitry, or a combination thereof.

For simplicity of explanation, the method 1800 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1802, a system can compare an acceleration of an object to a prediction of an acceleration for the object, and determine a deviation between the acceleration and the prediction. For example, the system could be the system 300 of FIG. 3. The system could be implemented by the controller 114 of FIG. 1. The system could be implemented by the vehicle 100 of FIG. 1, the vehicle 202 of FIG. 2, or the vehicle 402 of FIG. 4. The vehicle could be an AV. The vehicle could be traversing in the transportation network 208 of FIG. 2 or the vehicle transportation network 408 of FIG. 4. For example, the vehicle could be traveling in a residential area. The prediction of the acceleration, and the deviation between the acceleration and the prediction, may be used to determine whether the object is a BoS hazard. For example, the system may determine a magnitude of the deviation between the acceleration and the prediction, and determine the object is a BoS hazard based on the magnitude exceeding a threshold. In some implementations, the magnitude of the deviation between the acceleration and the prediction may be a factor of one or more multiple factors to determine that an object is a BoS hazard.

At 1804, the system can compare an angle of the object, relative to a lane in the vehicle transportation network, to a prediction of the angle, and determine a deviation between the angle and the prediction. The prediction of the angle, and the deviation between the angle and the prediction, may be used to determine whether the object is a BoS hazard. For example, the system may determine a magnitude of the deviation between the angle and the prediction, and determine the object is a BoS hazard based on the magnitude exceeding a threshold. In some implementations, the magnitude of the deviation between the angle and the prediction may be a factor of one or more multiple factors used to determine whether the object is a BoS hazard.

At 1806, the system can compare a speed of the object to a prediction of the speed, and determine a deviation between the speed and the prediction. The prediction of the speed, and the deviation between the speed and the prediction, may be used to determine whether the object is a BoS hazard. For example, the system may determine a magnitude of the deviation between the speed and the prediction, and determine the object is a BoS hazard based on the magnitude exceeding a threshold. In some implementations, the magnitude of the deviation between the speed and the prediction may be a factor of one or more multiple factors used to determine whether the object is a BoS hazard.

At 1808, the system can compare a position of the object, relative to a lane in the vehicle transportation network, to a prediction of the position, and determine a deviation between the position and the prediction. The prediction of the position, and the deviation between the position and the prediction, may be used to determine whether the object is a BoS hazard. For example, the system may determine a magnitude of the deviation between the position and the prediction, and determine the object is a BoS hazard based on the magnitude exceeding a threshold. In some implementations, the magnitude of the deviation between the position and the prediction may be a factor of one or more multiple factors used to determine whether the object is a BoS hazard.

Herein, the terminology “passenger”, “driver”, or “operator” may be used interchangeably. Also, the terminology “brake” or “decelerate” may be used interchangeably. As used herein, the terminology “processor”, “computer”, or “computing device” includes any unit, or combination of units, capable of performing any method, or any portion or portions thereof, disclosed herein.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. In some implementations, instructions, or a portion thereof, may be implemented as a special-purpose processor or circuitry that may include specialized hardware for carrying out any of the methods, algorithms, aspects, or combinations thereof, as described herein. In some implementations, portions of the instructions may be distributed across multiple processors on a single device, or on multiple devices, which may communicate directly or across a network, such as a local area network, a wide area network, the Internet, or a combination thereof.

As used herein, the terminology “example,” “embodiment,” “implementation,” “aspect,” “feature,” or “element” indicate serving as an example, instance, or illustration. Unless expressly indicated otherwise, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or.” That is, unless specified otherwise or clearly indicated otherwise by the context, “X includes A or B” is intended to indicate any of the natural inclusive permutations thereof. If X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

Further, for simplicity of explanation, although the figures and descriptions herein may include sequences or series of operations or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and/or elements.

While the disclosed technology has been described in connection with certain embodiments, it is to be understood that the disclosed technology is not to be limited to the disclosed embodiments but, on the contrary, is intended to cover various modifications and equivalent arrangements included within the scope of the appended claims, which scope is to be accorded the broadest interpretation as is permitted under the law so as to encompass all such modifications and equivalent arrangements.

What is claimed is:

1. A method, comprising:
determining, from a vehicle traversing in a vehicle transportation network, movement information associated with an object traveling in front of the vehicle and road information associated with the vehicle transportation network;
determining a probability of the object representing a backup or stopping (BoS) hazard to the vehicle, the probability based on the movement information and the road information;
assigning a BoS classification to the object based on the probability exceeding a threshold;
calculating, based on assigning the BoS classification, a risk zone representing a target minimum separation distance between the vehicle and the object; and
controlling the vehicle to avoid the risk zone by constraining a speed of the vehicle.

2. The method of claim 1, further comprising:
removing the BoS classification based on a reduction in the probability, the reduction caused by a determination that the object is resuming a predicted trajectory.

3. The method of claim 1, further comprising:
removing the BoS classification based on a reduction in the probability, the reduction caused by at least one of the object exceeding a range from the vehicle or the object transitioning to a stationary hazard.

4. The method of claim 1, wherein determining the movement information comprises:
comparing an acceleration of the object to a prediction of the acceleration; and
determining a deviation between the acceleration and the prediction.

5. The method of claim 1, wherein determining the movement information comprises:
comparing an angle of the object, relative to a lane in the vehicle transportation network, to a prediction of the angle; and
determining a deviation between the angle and the prediction.

6. The method of claim 1, wherein the target minimum separation distance is calculated based on a multiple of a length of the vehicle.

7. The method of claim 1, wherein the object is a lead vehicle, and the risk zone is calculated to enable the lead vehicle to at least one of parallel park or complete a three point turn.

8. The method of claim 1, wherein the object is a lead vehicle, and the risk zone is calculated to enable the lead vehicle to return to a stop line after initially passing the stop line.

9. The method of claim 1, wherein the risk zone is calculated based on an estimated future position of the object.

10. The method of claim 1, further comprising:
detecting light indicators associated with the object, wherein the probability is further based on the light indicators.

11. An apparatus, comprising:
a memory; and
a processor configured to execute instructions stored in the memory to:
determine, from a vehicle traversing in a vehicle transportation network, movement information associated with an object traveling in front of the vehicle and road information associated with the vehicle transportation network;
determine a probability of the object representing a backup or stopping (BoS) hazard to the vehicle, the probability based on the movement information and the road information;
assign a BoS classification to the object based on the probability exceeding a threshold;
calculate, based on assigning the BoS classification, a risk zone representing a target minimum separation distance between the vehicle and the object; and
controlling the vehicle to avoid the risk zone by constraining a speed of the vehicle.

12. The apparatus of claim 11, wherein the processor is further configured to execute instructions stored in the memory to:
remove the risk zone based on a reduction in the probability, the reduction caused by a determination that the object is resuming a predicted trajectory.

13. The apparatus of claim 11, wherein the processor is further configured to execute instructions stored in the memory to:
compare a speed of the object to a prediction of the speed; and
determine a deviation between the speed and the prediction.

14. The apparatus of claim 11, wherein the processor is further configured to execute instructions stored in the memory to:
compare a position of the object, relative to a lane in the vehicle transportation network, to a prediction of the position; and
determine a deviation between the position and the prediction.

15. The apparatus of claim 11, wherein the processor is further configured to execute instructions stored in the memory to:
determine a magnitude of a deviation from a prediction.

16. A non-transitory computer readable medium storing instructions operable to cause one or more processors to perform operations comprising:
determining, from a vehicle traversing in a vehicle transportation network, movement information associated with an object traveling in front of the vehicle and road information associated with the vehicle transportation network;
determining a probability of the object representing a backup or stopping (BoS) hazard to the vehicle, the probability based on the movement information and the road information;
assigning a BoS classification to the object based on the probability exceeding a threshold;
calculating, based on assigning the BoS classification, a risk zone representing a target minimum separation distance between the vehicle and the object; and
controlling the vehicle to avoid the risk zone by constraining a speed of the vehicle.

17. The non-transitory computer readable medium of claim 16, wherein the road information indicates a speed limit associated with a residential area, presence of an oncoming lane, an absence of a parallel lane in the same direction, and an absence of lane markings.

18. The non-transitory computer readable medium of claim 16, wherein the road information includes a detection of a gap between parked vehicles.

19. The non-transitory computer readable medium of claim 16, wherein the operations further comprise:
removing the BoS classification and the risk zone based on a reduction in the probability.

20. The non-transitory computer readable medium of claim 16, wherein the probability is based on a number of deviations between detected and prediction conditions.
